(19) United States
(12) Patent Application Publication
(10) Pub. No.: US 2026/0138323 A1
(43) Pub. Date: May 21, 2026

(54) WATER REMOVAL DEVICE

(71) Applicant: BRÜCKNER MASCHINENBAU GmbH, Siegsdorf (DE)

(72) Inventors: Anton EDFELDER, Unterwössen (DE); Anthimos GIAPOULIS, Traunstein (DE)

(21) Appl. No.: 19/395,475

(22) Filed: Nov. 20, 2025

(30) Foreign Application Priority Data
Nov. 21, 2024 (DE) 10 2024 134 338.9

(51) Int. Cl. B29C 48/88; B08B 5/02; B29C 48/00; B29C 48/08; B29C 48/27; B29C 48/355

(52) U.S. Cl. CPC B29C 48/919; B08B 5/026; B29C 48/0018; B29C 48/08; B29C 48/274; B29C 48/355; B29C 48/914

(57) ABSTRACT

A water removal device for removing water from a film is disclosed including at least one mechanical water removal mechanism, a first blower device, and a second blower device, which each include blower nozzles. The blower nozzles are set up to direct an airflow L towards the film in order to blow off water carried along with the film F over an edge of the film.

### CROSS REFERENCE TO RELATED APPLICATION

This application claims priority to German Patent Application Number DE 10 2024 134 338.9, filed Nov. 21, 2024, the entire contents of which is hereby incorporated by reference.

### FIELD OF THE DISCLOSURE

The disclosure relates to a water removal device for removing water from a film, a casting device comprising a water removal device and a system for manufacturing a film, comprising a corresponding casting device.

### BACKGROUND

When manufacturing thin plastic films, a plastic melt is first extruded and applied to a cooling roller, where it cools and solidifies at least partially (cast film). In order to cool the extruded film or cast film and then to be able to feed it into a stretching unit, the extruded film is typically passed through a water bath.

The water bath leads to a homogeneous and quick cooling; however, the water must be removed from the film before the film is fed to the stretching unit, in particular a longitudinal stretching unit.

This water removal is important, as water carried along with the film could enter the stretching unit and evaporate there. Typically, a longitudinal stretching system comprises heated rollers. Water remaining on the film surface would evaporate on these rollers, creating steam bubbles between the film and the roller. These steam bubbles lift the film off the roller and prevent the film from being heated evenly. This impairs the stretching result. The result would be poor film quality or even film breaks.

In addition, the evaporation of the water on the rollers leads to residues, such as chalk. Although decalcified water is typically used in water baths, the evaporation of decalcified water is not completely residue-free.

If water evaporates on the roller surface over a longer period of time, the roller can be permanently damaged by the deposits, especially since mechanical cleaning of the rollers is not possible as this would lead to scratches in the roller surface and thus to poor film quality.

Known water removal devices, which dry the film before it is fed to the stretching unit, often achieve an insufficient degree of dryness of the film. In addition, known water removal devices are not suited to high production speeds of at least 140 m/min (measured at the cooling roller), for example, as are now required. This is because high production speeds mean that the film carries more water away from the water bath and, at the same time, there is less time available to remove the water from the film. The result is that, especially at high production speeds, not enough water is removed from the film and it ultimately ends up in the stretching unit.

### SUMMARY

The present disclosure provides for an improved water removal device for manufacturing film.

There is a water removal device according to claim 1, and a casting device and a system for manufacturing a film from the additional claims. Further aspects of the disclosure are described in the dependent claims and in the following description.

In particular, there is a water removal device for removing water from a film. The water removal device can in particular be used during cast film manufacturing.

The water removal device comprises a film inlet opening and a film outlet opening and is set up to guide the film along a film path from the film inlet opening to the film outlet opening. The film path is thus the path that the film takes when passing through the water removal device. It is determined in particular by the positioning of rollers, such as deflection rollers, nip rollers, pressure rollers and/or the like. The rollers can be driven rollers or non-driven rollers. Preferably, at least one driven pressure roller is provided, which is designed to convey the film through the water removal device.

The water removal device comprises at least one mechanical water removal mechanism and at least one first blower device and a second blower device. The water can thus be removed from the surface of the film in two different ways, i.e. mechanically and through blowing. In this way, a particularly high water removal rate is achieved even at high film speeds. The blower devices are preferably downstream of the mechanical water removal mechanism, i.e. arranged after the mechanical water removal mechanism in the film withdrawal direction.

The mechanical water removal mechanism comprises at least two water removal elements which are arranged opposite each other on opposite sides of the film path. By way of example, a first water removal element is arranged on the upper side of the film path and a second water removal element is arranged on the upper side of the film path, such that both water removal elements guide the film between them.

The water removal elements apply a squeezing force to the film. This squeezing force causes the water on the upper side of the film to be squeezed out and thus mechanically removed.

The mechanical water removal mechanism forms, for example, a first water removal stage of the water removal device. In this case, it can be arranged after the inlet opening of the water removal device.

Optionally, a second mechanical water removal mechanism can be provided, which is downstream of the first mechanical water removal mechanism. The second mechanical water removal mechanism also has two water removal elements which are arranged opposite each other on opposite sides of the film path. These two water removal elements are set up to apply a squeezing force to the film. This allows any remaining water to be squeezed out, and thus removed mechanically, from the upper side of the film at a second position on the film path, which is different from the first position.

The water removal elements of the first and/or second water removal mechanism can be formed as squeeze rollers, for example. The squeeze rollers lying opposite each other form a squeeze roller pairing through which the film is passed. A mechanical water removal thus takes place.

The squeeze rollers can be coated with an elastic material, such as rubber, silicon, TPU (thermoplastic polyurethane) or similar. In this way, the water squeezing effect is increased.

Furthermore, a squeeze roller pairing can comprise two rollers of the same size or two rollers of different sizes. The rollers have, for example, a diameter in the range of from 100 mm to 200 mm, or in the range of from 120 mm to 180 mm, or in the range of from 140 mm to 160 mm. It has been shown that a good water squeezing effect can be achieved in this way.

Furthermore, at least one squeeze roller of the first and/or second water removal mechanism can be coupled to an actuator. In particular, at least one squeeze roller of a pair of squeeze rollers can be coupled to an actuator. The actuator can comprise a linear drive or a lever that allows the squeeze roller to be pivoted. The actuator can be used to adjust the squeezing force and/or the wrap angle of the roller. A squeeze roller of a pair of squeeze rollers that is not coupled to an actuator can, for example, be mounted on springs.

The first blower device of the water removal device according to the disclosure comprises at least one first blow nozzle and at least a second blow nozzle. The first blow nozzle(s) is/are arranged on a first side of the film path and the second blow nozzle(s) is/are arranged on a second side of the film path.

Accordingly, the second blower device of the water removal device according to the disclosure comprises at least a first blow nozzle and at least a second blow nozzle. The first blow nozzle(s) is/are arranged on a first side of the film path and the second blow nozzle(s) is/are arranged on a second side of the film path.

The blow nozzles are set up to direct an airflow towards the film in order to blow off water carried along by the film over at least one edge of the film. The water is thus blown off from the centre of the film over the left and/or right edge of the film.

Since the first blow nozzles of the first and second blower device are arranged on a first side of the film path, a first side of the film can be blown off at two different positions. At the latest after passing the second blower device, the first side of the film is (almost completely) free from water. Accordingly, this applies to the second blow nozzles of the first and second blower device, which are arranged at different positions on a second side of the film path.

At least one blow nozzle (or several blow nozzles, or all blow nozzles) can be assigned a blow roller. The assigned blow roller is arranged opposite the blow nozzle (i.e. on the opposite side of the film path) in order to support the film in the area that is blown off by the blow nozzle. It is thus possible to direct an airflow towards the film which has a sufficiently high pressure and/or a sufficiently high flow rate in order to effectively blow off the water without permanently deforming the film in doing so.

The at least one blow nozzle can be a slot nozzle which is substantially oriented transversely to the withdrawal direction of the film path. In this case, the slot nozzle is aligned parallel to the transverse direction of the film path. Alternatively, the slot nozzle can enclose an angle β with the transverse direction of the film path which lies in the range of from 1° to 45°, or in the range of from 10° to 30°, or in the range of from 15° to 20°.

The width of the slot nozzle can be selected in such a way that it substantially spans the whole film path in the transverse direction. It is also possible that multiple first (or second) blow nozzles are provided in a blower device. These can be arranged such that together they span the whole film path in the transverse direction, wherein edge regions of the blow nozzles can overlap each other. It is also possible to provide multiple blow nozzles in a blower device which are arranged one after the other in the withdrawal direction.

The slot nozzle can comprise at least one airflow outlet gap which is set up to generate a uniform, substantially laminar airflow. This can be directed towards the film such that water is blown off over one or both edges of the film.

In order to achieve this, the slot nozzle can be set up to direct the airflow onto the film in such a way that it has a flow component in the transverse direction. In particular, the airflow can be inclined relative to a film path normal, wherein the angle formed by the airflow with the film path normal can be in the range of from 1° to 5°, or in the range of from 2° to 4°. The inclination of the airflow can be achieved by a corresponding inclination of the slot nozzle and/or by a corresponding design of the airflow outlet gap. The inclination achieves particularly effective blowing off.

The water removal device can also comprise at least a left and/or right edge-blower device, which is/are downstream of the first and second blower device. The left edge-blower device is therefore assigned to a left edge of the film, and the right edge-blower device is assigned to a right edge of the film.

The edge-blower devices can each comprise a first edge-blower nozzle and at least a second edge-blower nozzle. The first edge-blower nozzle is arranged on a first side of the film path and the second edge-blower nozzle is arranged on a second side of the film path opposite the first edge-blower nozzle. The first and second edge-blower nozzles are thus arranged on opposite sides of the film path in substantially the same positions. The edge-blower device exclusively blows off one film edge. The airflow generated here does not slip over the whole film, but only its edge regions. This allows any water adhering to the film edge to be blown off.

Furthermore, the water removal device can comprise at least one air drying- and/or air tempering device. This can be set up to provide air that is fed to the first blower device, the second blower device, the left edge-blower device and/or the right edge-blower device in order to generate an airflow with a defined air humidity and/or temperature.

The air drying- and/or air tempering device can provide air at different temperatures and/or humidity levels to the different blower devices, or multiple air drying- and/or air tempering devices can be provided, which are each assigned to one of the blower devices.

By way of example, the air drying- and/or air tempering device can supply air at a temperature T1 to the first blower device, air at a temperature T2 to the second blower device and air at a temperature T3 to the edge-blower devices, wherein, for example, the following relationship applies:

$$T 1 \leq T 2 \leq T 3$$

This has the advantage that the film is already (pre-)tempered for the longitudinal and/or transverse stretching that typically follows.

Furthermore, the air drying- and/or air tempering device can comprise a filter, such that filtered air can be supplied to the blower devices.

Furthermore, the first blower device, the second blower device, the left edge-blower device and/or the right edge-blower device can be set up to supply the airflow with a defined airflow rate and/or a defined pressure.

By way of example, the second blower device can supply an airflow which has a higher airflow rate and/or a higher pressure than the airflow supplied by the first blower device. The airflow supplied by the edge-blower devices can have a further increased pressure and/or a further increased airflow rate.

It is also possible that the second blower device supplies an airflow that has a lower airflow rate and/or a lower pressure than the airflow supplied by the first blower device. The airflow supplied by the edge-blower devices can have a further reduced pressure and/or a further reduced airflow rate.

In one aspect, the first blower device supplies an airflow having a first pressure and a first airflow amount. The first pressure can lie, for example, in a range of from 0.5 to 1.1 bar, or in a range of from 0.6 to 0.8 bar. The first airflow amount can lie, for example, in a range of from 1000 m³/h to 1600 m³/h, or in a range of from 1200 m³ to 1400 m³/h. The second, following blower device could then supply a second airflow having a second pressure and a second airflow amount, wherein the second pressure is increased and the second airflow amount is reduced. This pressure and airflow amount distribution enables the majority of the water to be blown off the film surface with the first blower device. The remaining moisture or droplets can then be removed (with high pressure) in the second blower device.

The water removal device can further comprise a main body and at least one flap element. Preferably, the water removal device comprises at least two flap elements.

The at least one flap element is pivotably arranged on the main body in order to be pivoted from a first position into a second position, wherein in the first position the water removal device is in an operating position and in a second position is in a maintenance position. In the maintenance position, for example, a film can be inserted into the water removal device, or a film can be removed from the water removal device after a malfunction—such as a film tear. For this purpose, the main body is separated from the at least one flap element along the film path.

Furthermore, the water removal device can comprise an air extractor which is set up to extract moist air from the housing of the water removal device. The efficiency of the water removal device can thus be further improved.

Further, there is a casting device for plastic film manufacturing, wherein the casting device comprises a cooling roller, a take-off roller, at least one water bath and a water removal device of the type described above.

The cooling roller is set up to cool plastic melt extruded onto its surface in order to produce a film. The take-off roller is downstream of the cooling roller and is set up to detach the film from the cooling roller. In particular, the cooling roller can be set up in order to rotate so quickly that the film is removed with a film speed of at least 120 m/min, or at least 130 m/min, or at least 140 m/min, or at least 150 m/min, or at least 160 m/min.

The at least one water bath is arranged such that the film in the casting device is guided through the at least one water bath. By way of example, the cooling roller, and optionally the take-off roller, are at least partially arranged in the water bath. Alternatively or additionally, a water bath can be downstream of the take-off roller, through which water bath the film is guided (e.g. via corresponding deflection rollers).

The water removal device is arranged such that the film passes the water removal device before leaving the casting device in order to remove water from the surface of the film.

Furthermore, the casting device can comprise a water treatment system, in particular a decalcification system, wherein the water treatment system is set up to treat the water of the at least one water bath. In particular, impurities such as chalk and/or other residues can be removed from the water in the water bath. In this way, the film quality can be improved.

Furthermore, there is a system for manufacturing a film, wherein the system comprises at least one device for providing a plastic melt and the above-mentioned casting device. The device for providing a plastic melt can comprise an extrusion nozzle, an extruder and/or a reactor. In particular, the device for providing a plastic melt can be set up to extrude the plastic melt onto the cooling roller.

The extruder can be set up to provide a plastic melt (e.g. PE, PP, PET . . . ).

A reactor can be set up to produce the plastic melt by means of polymerisation. For this purpose, the monomers (and optionally admixtures, such as catalysts) are mixed in the reactor and polymerised. The resulting polymerised plastic melt can then be supplied to an extrusion nozzle and extruded onto the cooling roller, such that no additional extruder is required.

Furthermore, the system can comprise a stretching unit, which is downstream of the casting device, and which is set up to stretch the film F in the longitudinal direction and/or transverse direction. The stretching in the longitudinal and transverse direction can occur simultaneously or sequentially.

### BRIEF DESCRIPTION OF THE DRAWINGS

Additional features and advantages of the disclosure are found in the following description as well as the attached drawings to which reference is made. In the drawings:

FIG. 1 is a schematic depiction of a system for manufacturing a film;

FIG. 2 is an exemplary casting device;

FIG. 3 is an isometric depiction of a water removal device;

FIG. 4 is a sectional view of the water removal device from FIG. 3;

FIG. 5 is a schematic illustration of the blowing off of the film in an exemplary embodiment; and,

FIG. 6 is a schematic illustration of the blowing off of the film in an exemplary embodiment.

### DETAILED DESCRIPTION

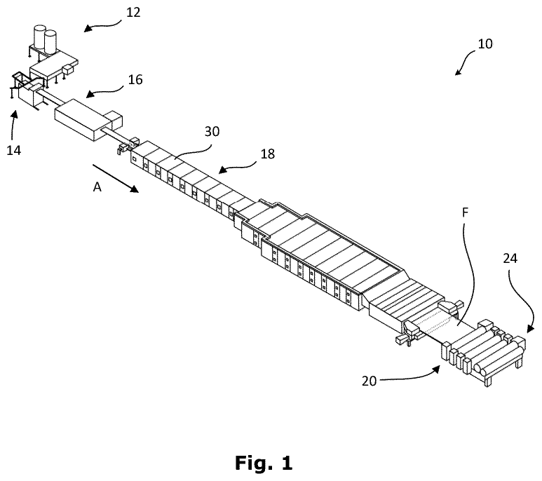

FIG. 1 shows, extremely schematically, a system 10 for manufacturing a film F, which comprises multiple different devices and systems.

In the example shown, the system 10 has an extrusion system 12, a casting device 14, at least one longitudinal stretching unit 16 (MDO, “Machine Direction Orienter”), a transverse stretching unit 18 (TDO, “Transverse Direction Orienter”), an optional treatment device 20 and a winding device 24. The optional treatment device 20 can be a separate assembly, or integrated in the winding device 24, for example.

The extrusion system 12 has at least one extruder 120 and/or melt feed line from a reactor and is set up to produce a melt from at least one starting product. The starting product can comprise plastic granulate, plastic powder, recycled plastic, admixtures and/or the like, for example.

The at least one extruder can be a single-screw extruder, cascade extruder, twin-screw extruder, planetary roller extruder and/or the like. It is also conceivable that other mixing and processing units, such as a co-kneader, for example, are used.

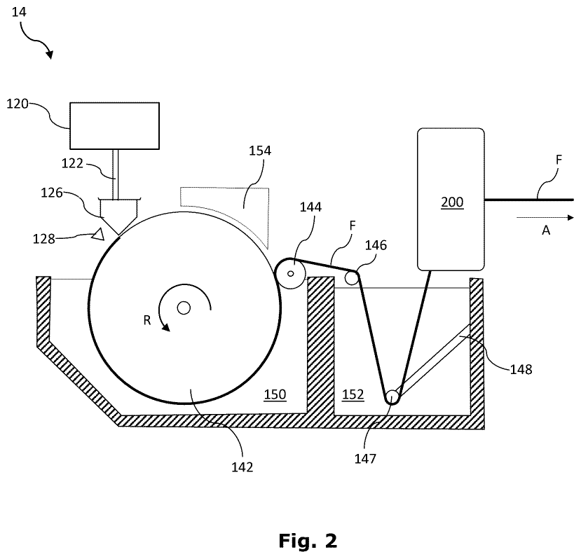

Using an extrusion nozzle, such as a wide slot nozzle 126, the melt produced (via an optional melt feed line 122) is applied to a cooling roller 142 of the casting device 14, whereby a film F is produced. Optionally, a so-called application device 128 is provided (see FIG. 2), with which the melt emerging from the extrusion nozzle can be precisely applied to the cooling roller and fixed there. The precise application results in uniform cooling and high-quality surfaces of the film.

It is also possible to produce the plastic melt by means of polymerisation. Here, the monomers (and optional admixtures, such as catalysts) are mixed in a reactor and/or in an extruder and polymerised. The resulting polymerised plastic melt can be applied to the cooling roller 142 of the casting device 14 by means of a melt feed line 122 using the extrusion nozzle (e.g. the wide slot nozzle 126), whereby a film F is produced.

The extruded film F can have one or more layers. In the case of a multilayer film, it is conceivable that an extruder produces multiple or all layers, or that an extruder is provided for each layer.

After passing through the casting device 14, the film F is fed into a longitudinal stretching unit 16 in the example shown here. In this unit, the film is stretched in a first direction, i.e. in the withdrawal direction A, and thus elongated.

The adjoining transverse stretching unit 18, as is described in DE 10 2021 128 332 A1, for example, has a furnace 30 with different zones for tempering the film F along the usual movement direction or withdrawal direction A of the system 10. In the furnace 30, the film F is stretched in a known manner in the transverse direction, i.e. transversely to the direction of withdrawal A. This makes it possible to produce a mono- or biaxially oriented film.

Instead of two separate stretching units 16, 18 for longitudinal and transverse stretching, a simultaneous stretching unit can also be used. In this unit, the film is stretched in the longitudinal and transverse directions simultaneously.

The treatment device 20 is, for example, a device for activating the surface of the film F through a corona treatment, for example in order to implement a better metal adhesion.

The winding device 24 serves to wind up the produced film F and is the last device in the withdrawal direction A. It has a winding core on which the film F is wound up.

In FIG. 2, the casting device 14 (also called the cooling roller unit) is depicted in an enlarged schematic view.

The casting device 14 shown here comprises the wide slot nozzle 126, the cooling roller 142 and an application device 128.

The wide slot nozzle 126 is arranged above the cooling roller 142 and is formed to continuously apply the plastic melt to the cooling roller 142, which forms the film F. The plastic used is in particular a polyethylene (PE), a polypropylene (PP), a polyethylene terephthalate (PET), and/or similar. It is also possible to combine different plastics. In particular, a film can have different plastic layers and/or different plastics can be co-extruded in one layer.

The film F is then evenly applied to the cooling roller 142 by means of the application device 128. The cooling roller 142 rotates counterclockwise (direction of rotation R) as shown in FIG. 2. The film F produced in this way is finally, in the exemplary embodiment shown after approximately three-quarters of a turn of the cooling roller 142, detached from the cooling roller 142, cooled and fed to a stretching unit 16, 18.

To detach the film F from the cooling roller 142, the casting device 14 comprises a take-off roller 144, downstream of which are multiple deflection rollers 146, 147. The deflection roller 147 is arranged on a tensioning element 148. The tensioning element is formed here as a pivotable lever. The tension of the film F can be set or regulated via the angular position of the lever.

As shown, the cooling roller 142 can be arranged in a first water bath in order to cool the extruded film F and the cooling roller 142. After the take-off roller 144, which serves to detach the extruded film F from the cooling roller 142, the film F can be guided through a further water bath 152 (or the water bath 150) by means of the deflection rollers 146, 147, in order to achieve further cooling off.

The water adhering to the film F must be removed from the film surface before the film is stretched in a longitudinal, transverse or simultaneous stretching unit 16, 18. This is necessary in order to obtain the highest possible film quality and to avoid deposits on the rollers (e.g. of the longitudinal stretching unit 16) that would result from the evaporation of the water.

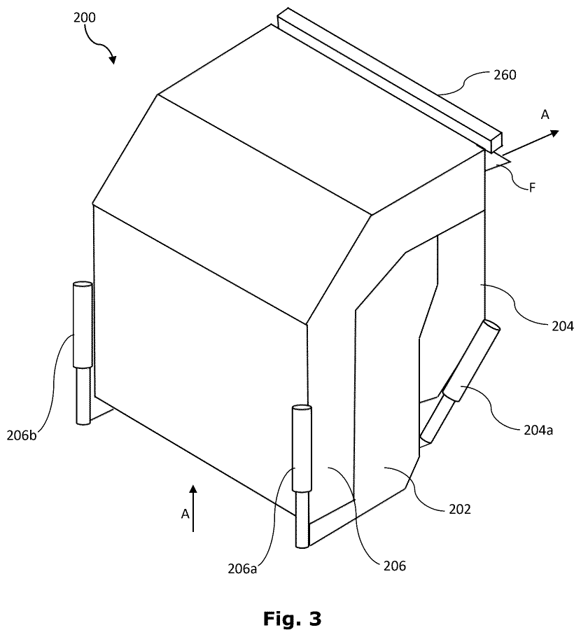

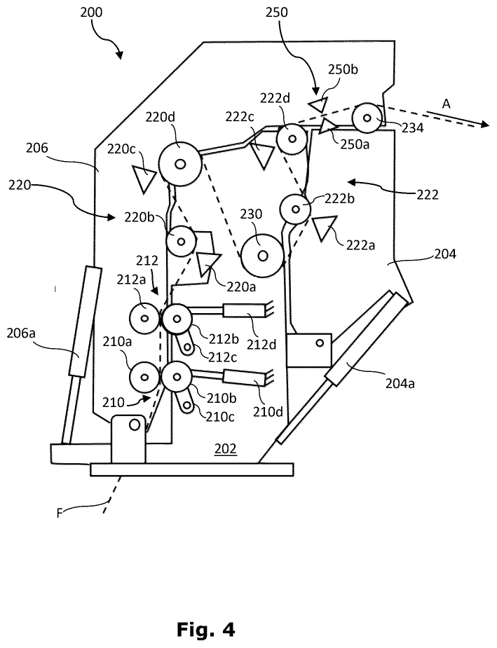

A film drying device 200 is provided to remove the water from the film surface. An exemplary film drying device 200 is described below with reference to FIGS. 3 and 4.

Furthermore, a water removal device 154 can be provided, which is assigned to the cooling roller 142. This water removal device 154 removes any water adhering to the cooling roller 142, such that the melt can be extruded on a substantially dry cooling roller 142. For this purpose, the water removal device 154 can comprise at least one water stripping device, at least one blower, at least one blower nozzle (in particular an air knife nozzle) and/or similar.

FIG. 3 shows an isometric representation of a water removal device 200, and FIG. 4 shows a sectional view of the water removal device 200.

The water removal device 200 comprises a main body 202, a first flap element 204 and a second flap element 206. The flap elements 204, 206 are pivotably arranged on the main body 202 and can be pivoted from a first position (depicted here) to a second position. In the first position, the water removal device is in an operating position. In the second position, the water removal device is in a maintenance position. By pivoting the flap elements 204, 206, the water removal device 200 can be opened. The enables, amongst other things, the insertion of a film F along the film path.

As is shown in particular in the sectional view of FIG. 4, the main body 202 is separated along the film path from both flap elements 204, 206.

The pivoting of the first flap element 204 can be actuated by means of a drive, in particular a hydraulic drive 204a. The pivoting of the second flap element 206 can also be actuated by means of a drive, in particular the hydraulic drive 206a, 206b.

In the exemplary embodiment shown, the film F is guided through a film inlet opening (in FIG. 3, at the bottom) into the water removal device 200 and from there, guided along the film path in the withdrawal direction A through the water removal device 200. The film leaves the water removal device 200 again at a film outlet opening (in FIG. 3, pointing to the rear right). A driven nip roller 234 is provided adjacent to the film outlet opening (see FIG. 4). This can pull the film through the water removal device 200, even after a break. Furthermore, a transverse cutting device 260 can be provided, which is set up to cut the film transversely after it has passed through the film outlet opening.

FIG. 4 shows a water removal device 200 in a sectional view. The water removal device 200 comprises a first mechanical water removal mechanism 210, a second mechanical water removal mechanism 212, a first blower device 220 and a second blower device 222, which the film F passes in this order. An edge-blower device 250 is provided after the second blower device 222.

In the example shown here, the first mechanical water removal mechanism 210 comprises two squeeze rollers 210a, 210b, which are arranged opposite each other on opposite sides of the film path. The squeeze rollers 210a, 210b lying opposite each other form a squeeze roller pairing through which the film F is guided. A mechanical water removal thus takes place.

The squeeze roller 210b is arranged on a lever 210c and is coupled to an actuator 210d. The actuator 210b can be used to adjust the squeezing force and/or a wrap-around angle of the squeeze roller 210b. The squeeze roller 210a is mounted on springs.

In the example shown here, the second mechanical water removal mechanism 212 also comprises two squeeze rollers 212a, 212b, which are arranged opposite each other on opposite sides of the film path. The squeeze rollers 212a, 212b lying opposite each other form a squeeze roller pairing through which the film F is guided. A further mechanical water removal thus takes place.

The squeeze roller 212b is arranged on a lever 212c and is coupled to an actuator 212d. The actuator 212b can be used to adjust the squeezing force and/or a wrap-around angle of the squeeze roller 212b. The squeeze roller 212a is mounted on springs.

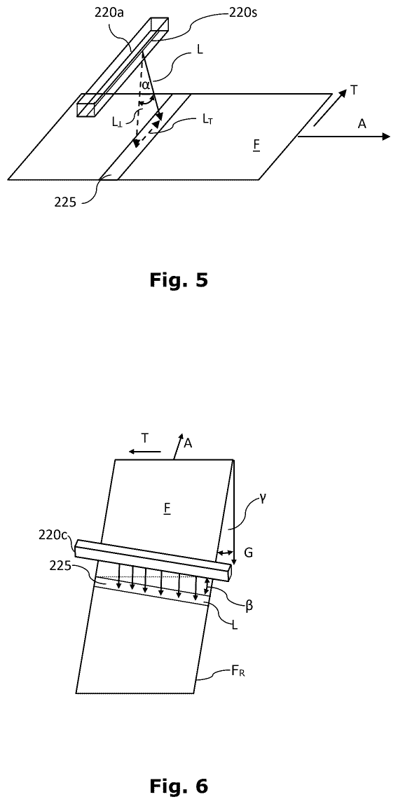

The first blower device 220, which is downstream of the second mechanical water removal mechanism 212 here, comprises a first blower nozzle 220a and a second blower nozzle 220c. The first blower nozzle 220a is arranged on a first side of the film path and the second blower nozzle 220c is arranged on a second side of the film path. A blower roller 220b, 220d is arranged in each case opposite the blower nozzles, which can be formed as slot nozzles here (see also FIG. 5). The blower nozzles 220a, 220c are set up to direct an airflow towards the film F, in order to blow off water carried along by the film F over at least one film edge (left and/or right).

The film F is guided to the second blower device 222 via a deflection roller 230. The deflection roller 230 can be driven to convey the film.

The second blower device 222 comprises a first blower nozzle 222a and a second blower nozzle 222c. The first blower nozzle 222a is arranged on a first side of the film path and the second blower nozzle 222c is arranged on a second side of the film path. A blower roller 222b, 222d is arranged in each case opposite the blower nozzles, which can be formed as slot nozzles here (see also FIG. 5). The blower nozzles 222a, 222c are set up to direct an airflow towards the film F, in order to blow off water still found on the film F over at least one film edge (left and/or right).

After passing through the second blower device 222, the film can optionally be guided past edge-blower devices 250. An edge-blower device can be provided for the left film edge and for the right film edge in each case. The edge-blower devices comprise a first edge-blower nozzle 250a and at least one second edge-blower nozzle 250b in each case. The first edge-blower nozzle 250a is arranged on the first side of the film path and the second edge-blower nozzle 250b is arranged on the second side of the film path, opposite the first edge-blower nozzle 250a. The edge-blower device exclusively blows off the corresponding film edge. The airflow generated here thus does not pass over the whole film F, but rather only its edge regions. Any water adhering to the film edge can thus be blown off.

FIG. 5 schematically shows the blowing off of the film by means of a blower device, which comprises a blower nozzle 220a. The blower nozzle 220a is depicted schematically here and is formed as a slot nozzle. It comprises an airflow outlet gap 220s. The airflow outlet gap 220s is set up to produce a uniform, substantially laminar airflow L. This is directed towards the film such that water is blown off over one or both film edges.

In order to achieve this, the slot nozzle can be set up to direct the airflow L onto the film F in such a way that it has a flow component L_{T} in the transverse direction T. In particular, the airflow can be inclined relative to a film path normal L_{⊥}, wherein the angle α formed by the airflow L with the film path normal L_{⊥} can be in the range of from 1° to 5°. The airflow L is represented here only by an arrow with a solid line. It is understood, however, that the airflow exits across the entire width of the airflow outlet gap and thus covers the 225 blow-off region.

In FIG. 6, the blowing off of the film F is shown by means of a further blower device, which comprises a blower nozzle 220c. In this embodiment, the film F is conveyed upwards. The withdrawal direction A is inclined at an angle γ relative to the vertical G. Thus, water carried along can already flow off the film due to the force of gravity. The blower nozzle 220c is set up to produce a uniform, substantially laminar airflow L. This is directed towards the film F, such that water is held back and thus blown off. In addition, the blower nozzle 220c can be positioned transversely to the transverse direction of the film T by the angle β. This oblique orientation of the blower nozzle and thus of the blow-off region 225 enables the water carried along to be blown off over the film edge FR.

1. A water removal device for removing water from a film (F), comprising:
a film inlet opening and a film outlet opening, and is set up to guide the film (F) along a film path from the film inlet opening to the film outlet opening;
at least one mechanical water removal mechanism, which has at least two water removal elements, which are arranged opposite each other on opposite sides of the film path and are set up to apply a squeezing force to the film (F);
a first blower device and a second blower device, wherein
the first blower device comprises at least one first blower nozzle and at least one second blower nozzle, wherein the first blower nozzle is arranged on a first side of the film path and the second blower nozzle is arranged on a second side of the film path;
wherein the second blower device comprises at least one first blower nozzle and at least one second blower nozzle, wherein the first blower nozzle is arranged on the first side of the film path and the second blower nozzle is arranged on the second side of the film path; and
wherein the blower nozzles are set up to direct an airflow (L) towards the film in order to blow off water carried along with the film (F) over at least one film edge.

2. The water removal device according to claim 1, further comprising a second mechanical water removal mechanism which is downstream of the first mechanical water removal mechanism, and which has at least two water removal elements which are arranged opposite each other on opposite sides of the film path and are set up to apply a squeezing force to the film (F).

3. The water removal device according to claim 1, wherein the water removal elements of at least one of the first or second water removal mechanism are formed as squeeze rollers, and
wherein at least one squeeze roller of at least one of the first or second water removal mechanism is coupled to an actuator.

4. The water removal device according to claim 1, wherein
at least one blower nozzle is assigned a blower roller, wherein
the assigned blower roller of the blower nozzle is arranged opposite, in order to support the film (F) in the region which is to be blown off by the blower nozzle.

5. The water removal device according to claim 1, wherein
at least one blower nozzle is a slot nozzle, which is substantially orientated transversely to the film path, or which encloses an angle β with the transverse direction (T) of the film path, wherein β lies in the range of from 1° to 45°.

6. The water removal device according to claim 5, wherein the slot nozzle is set up to direct the airflow (L) towards the film (F) in such a way that it has a flow component (L_{T}) in the transverse direction (T).

7. The water removal device according to claim 1, further comprising at least one of at least one left or right edge-blower device, which is downstream of the first and second blower device, wherein the left edge-blower device is assigned to a left film edge and wherein the right edge-blower device is assigned to a right film edge.

8. The water removal device according to claim 1, wherein
the water removal device comprises at least one of an air-drying device or an air-tempering device, and wherein
at least one of the air-drying or air-tempering device is set up to supply air, which is fed to at least one of the first blower device, the second blower device, the left edge-blower device or the right edge-blower device in order to produce an airflow, with at least one of a defined humidity or temperature.

9. The water removal device according to claim 1, wherein
at least one of the water removal device the first blower device, the second blower device, the left edge-blower device or the right edge-blower device is set up to supply the airflow with at least one of a defined airflow rate or a defined pressure,
wherein the second blower device supplies an airflow which has at least one of a higher airflow rate or a higher pressure than the airflow supplied by the first blower device.

10. The water removal device according to claim 1, further comprising a main body and at least one flap element, and wherein
the at least one flap element is pivotably arranged on the main body in order to be pivoted from a first position into a second position, wherein
in the first position the water removal device is in an operating position and in the second position is in a maintenance position, and wherein the main body is separated along the film path from the at least one flap element.

11. The water removal device according to claim 1, further comprising an air suction which is set up to suction humid air out of the housing of the water removal device.

12. A casting device for manufacturing plastic films, wherein
the casting device comprises a cooling roller, a take-off roller, at least one water bath and the water removal device according to claim 1, wherein
the cooling roller is set up to cool off a plastic melt extruded on its surface in order to produce a film (F), wherein
the take-off roller is downstream of the cooling roller and is set up to detach the film (F) from the cooling roller, wherein the at least one water bath is arranged such that the film (F) is guided in the casting device through the at least one water bath, and wherein
the water removal device is arranged such that the film (F) passes the water removal device before leaving the casting device in order to remove water from the surface of the film (F).

13. The casting device according to claim 12, further comprising
a water treatment system, wherein the water treatment system is set up to treat the water of the at least one water bath, wherein
the water treatment system can be a decalcification system.

14. A system for manufacturing a film (F), comprising:
at least one device for producing a plastic melt comprising at least one of an extruder or a reactor,
the casting device according to claim 12, and
wherein the extruder or the reactor is configured to supply a plastic melt and extrude it on the cooling roller.

15. The system according to claim 14, further comprising
a stretching unit which is downstream of the casting device and which is set up to stretch the film (F) at least in one of a longitudinal or transverse direction.
